(19) United States
(12) Patent Application Publication
(10) Pub. No.: US 2015/0378937 A1
(43) Pub. Date: Dec. 31, 2015

(54) SYSTEMS AND METHODS FOR LOCKING CACHED STORAGE

(71) Applicant: HGST Netherlands B.V., Amsterdam (NL)

(72) Inventors: Henglin YANG, Cedar Knolls, NJ (US); Pulkit MISRA, Belmont, MA (US); Jonathan DEPRIZIO, Cambridge, MA (US)

(21) Appl. No.: 14/316,214

(22) Filed: Jun. 26, 2014

(51) Int. Cl. G06F 12/14; G06F 12/08; G06F 12/12

(52) U.S. Cl. CPC G06F 12/1491; G06F 12/128; G06F 12/0848; G06F 2212/1052; G06F 2212/69; G06F 2212/282

(57) ABSTRACT

The present disclosure relates to systems and methods for locking a storage device to prevent inadvertent modification when the device is mounted on a different system or different host. The method can include selecting, on a storage device, a location and contents of a byte region for locking, where the byte region comprises a boot sector of the device. The method can also include encoding the selected contents of the byte region, and locking the device by replacing the contents of the identified byte region with the encoded byte region at the identified location on the device. In some embodiments, encoding the selected contents of the byte region can include inverting the contents of the selected byte region using a binary not operation. In some embodiments, encoding the selected contents of the byte region can include modifying the selected contents of the byte region based on a generated unique identifier.

### BACKGROUND

1. Field of the Disclosure

The present disclosure relates to systems and methods for locking of storage devices in operating systems, and specifically to systems and methods for preventing storage from being mounted in an operating system.

2. Related Description

A cache can generally be used to speed access when reading or writing data to underlying storage such as a flash memory or hard drive. The storage may also be usable in multiple hosts. For example, if the storage is sufficiently large, the storage can store data from multiple computers at the same time. When the storage is first connected to a computer, an operating system running on the computer first mounts, or prepares for use, the storage before it can be accessed. In general, the operating system mounts the storage to make available files and directories (i.e., a file system) for use on the storage device. The mount process can begin with a disk manager in the operating system loading a partition table on the storage device. The partition table generally describes to the disk manager what partitions, or subdivisions, exist on the storage device, and what file systems exist on the storage device.

### SUMMARY

Embodiments of the present disclosure relate to systems and methods for locking a storage device to prevent inadvertent modification when the storage device is mounted (i.e., loaded for use) on a different system or different host.

Embodiments of the present disclosure also relate to systems and methods for determining a unique identifier corresponding to a storage device.

In one embodiment, the present disclosure relates to a method for locking a storage device. The method can include selecting, on a storage device, a location and contents of a byte region for locking, where the byte region comprises a boot sector of the storage device. The method can further include encoding the selected contents of the byte region, and locking the storage device by replacing the contents of the identified byte region with the encoded byte region at the identified location on the device.

In one embodiment, the present disclosure relates to a system for locking a storage device. The system can include a storage device and a processor. The storage device can contain a byte region, wherein the byte region comprises a boot sector of the storage device. The processor can be in communication with the storage device. The processor can be configured to select, on the storage device, a location and contents of the byte region for locking. The processor can be further configured to encode the selected contents of the byte region, and lock the storage device by replacing the contents of the identified byte region with the encoded byte region at the identified location on the device.

In one embodiment, the present disclosure relates to a method for unlocking a storage device. The method can include identifying an encoded byte region on the storage device. The method can further include, for each unique identifier stored in a collection of unique identifiers, decoding the encoded byte region based on the unique identifier. The method can further include determining whether the decoded byte region represents valid data, and replacing the encoded byte region with the decoded byte region upon a determination that the decoded byte region represents valid data.

The embodiments described herein can include additional aspects. For example, the methods and systems can further include the encoding the selected contents of the byte region including inverting the contents of the selected byte region using a binary not operation. Encoding the selected contents of the byte region can include compressing the selected contents of the byte region. Encoding the selected contents of the byte region can be performed on a cache, where the cache is separate from the storage device. Locking the storage device can include copying the encoded contents of the byte region from the cache to the identified location on the device in an atomic transaction. The boot sector can be arranged according to at least one of a master boot record (MBR) partition scheme and a globally unique identifier partition table (GPT) partition scheme. The byte region can include an MBR boot signature. The byte region can include at least one of (i) sector 0 of the storage device, (ii) a plurality of initial sectors of the storage device, (iii) an initial about 4-16 kilobytes of the storage device, and (iv) a partition boot record (PBR) for an individual partition on the storage device. The byte region can include at least one of a plurality of final sectors of the storage device, and a final about 4-16 kilobytes of the storage device. Encoding the selected contents of the byte region can include modifying the selected contents of the byte region based on a generated unique identifier. Encoding the selected contents of the byte region can include performing a binary exclusive-or (XOR) operation with the generated unique identifier and the byte region. The unique identifier can be generated according to a random function initiated with a globally constant random seed. Decoding the encoded byte region can be performed on a cache, where the cache is separate from the storage device, and determining whether the decoded byte region represents valid data can include comparing the decoded byte region with original contents of the byte region previously stored to the cache. The byte region can include a master boot record (MBR) boot signature, and determining whether the decoded byte region represents valid data can include comparing the decoded byte region with an original value of 0x55 AA for the MBR boot signature. Determining whether the decoded byte region represents valid data can include determining whether an operating system recognizes the storage device as containing a file system. Determining whether the operating system recognizes the storage device as containing a file system can be based on at least one of an lsblk utility and a blkid utility.

### BRIEF DESCRIPTION OF THE DRAWINGS

Various objects, features, and advantages of the present disclosure can be more fully appreciated with reference to the following detailed description when considered in connection with the following drawings, in which like reference numerals identify like elements. The following drawings are for the purpose of illustration only and are not intended to be limiting of the invention, the scope of which is set forth in the claims that follow.

FIG. 1 illustrates an example system for locking a target device, in accordance with some embodiments of the present disclosure.

FIG. 2 illustrates an example block diagram of a target device, in accordance with some embodiments of the present disclosure.

FIG. 3A illustrates an example block diagram of a target device including a master boot record (MBR), in accordance with some embodiments of the present disclosure.

FIG. 3B illustrates an example block diagram of a target device including a globally unique identifier partition table (GPT), in accordance with some embodiments of the present disclosure.

FIG. 4 illustrates an example method for locking a target device, in accordance with some embodiments of the present disclosure.

FIG. 5 illustrates an example temporary space on a cache, in accordance with some embodiments.

FIG. 6 illustrates an example block diagram of a target device including a master boot record (MBR), in accordance with some embodiments of the present disclosure.

FIG. 7 illustrates an example of modifying a byte region on a target device based on a unique identifier, in accordance with some embodiments of the present disclosure.

FIG. 8 illustrates an example target device mapping on a cache, in accordance with some embodiments of the present disclosure.

FIG. 9A illustrates a method for locking a target device using a unique identifier, in accordance with some embodiments of the present disclosure.

FIG. 9B illustrates a method for unlocking a target device, in accordance with some embodiments of the present disclosure.

### DETAILED DESCRIPTION

The present disclosure relates to systems and methods for locking a storage device to prevent inadvertent modification when the storage device is mounted (i.e., loaded for use) on a different system or different host. As used herein, the term “outside mount” can refer to mounting a storage device into a different system. The locking can thereby avoid undesired and inadvertent mounting of a protected device by a user or administrator, in a different host. In some embodiments, the locking can include encoding byte regions of a cached device. Examples of encoding byte regions can include inverting bits in the byte regions (e.g., changing the bits from 0 to 1 and 1 to 0). For example, the locking can include encoding a byte region in one or more sectors at the beginning and/or end of a cached device, such as a first and/or last about four to sixteen kilobytes of the cached device. These encoded sectors can correspond to areas on which the cached device stores a partition table. In some embodiments, the partition table can include a master boot record (MBR) or a globally unique identifier partition table (GPT). A disk manager in an operating system can use a partition table to mount a device or individual partition. More specifically, the storage device can be divided into one or more volumes, or partitions. The partition table can allow the operating system to determine the number and storage size of partitions on the target device. By encoding bits and/or sectors of the cached device corresponding to a partition table, the encoded byte region can prevent the cached device from being modified inadvertently on a different system. Therefore, a cached device having a partition table modified according to these methods would not be recognized by an operating system on a different host. The locking can cause the target device to be accessible only through the cache. The locking can thereby prevent a user from accidentally modifying the target device if the target device is inadvertently mounted outside of the cache. When remounted in the original system, upon receiving a cache read operation, the cache can reverse the bit inversion operations and unlock the device. The locking also provides an ability to detect if a target device has been modified outside its host system. For example, the system can identify whether an encoded byte region changed, while the target device was mounted in another host.

In some embodiments, the present disclosure also relates to systems and methods for determining a unique identifier corresponding to a storage device (e.g., a disk), without recording the unique identifier directly to a storage area of the device. In some embodiments, the unique identifier generation can include modifying a boot signature of a partition table on the target device based on the corresponding unique identifier, so as to lock the target device and prevent the target device from being mounted in a different host system.

### Device Lock Architecture

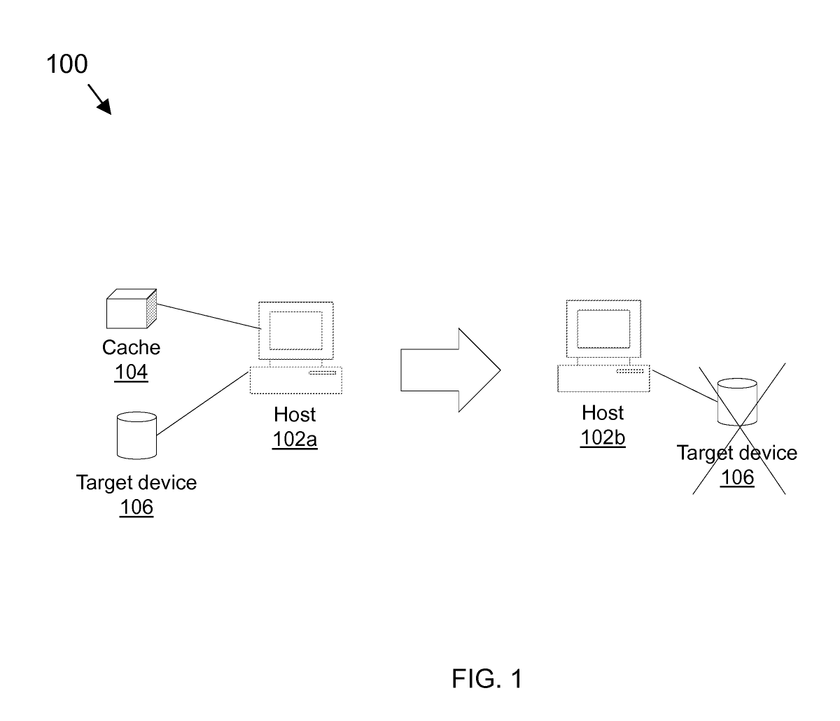

FIG. 1 illustrates an example system 100 for locking target device 106, in accordance with some embodiments of the present disclosure. FIG. 1 includes host systems 102a-102b, cache 104, and target storage device 106. Upon system startup of host 102a, cache 104 can generally represent an overall system state of host 102a. That is, data in cache 104 can represent an updated and current copy of the data on target device 106. As host 102a sends and receives input/output (I/O) operations to target device 106, cache 104 can be configured to act as a conduit for the I/O operations issued to target device 106. In this manner, cache 104 can keep its contents consistent with the contents of underlying target device 106.

However, in some situations cache 104 may not be able to process I/O operations issued to target device 106. For example, target device 106 can be removed and mounted in a second (different) system, such as host 102b. When target device 106 is removed and mounted in host 102b, host 102a can be unaware of the extent and location of changes made by host 102b to target device 106. As a result, cached data from target device 106 stored in cache 104 on host 102a can become stale. If target device 106 were then brought back to host 102a, cache 104 could incorrectly continue to use stale data previously stored that is inconsistent with any contents updated on target device 106 by host 102b. This inconsistent situation can lead to unwanted data corruption. Locking target device 106 prevents such corruption from happening due to an outside mount or unintentional access to target device 106, when the access does not go through host 102a via cache 104.

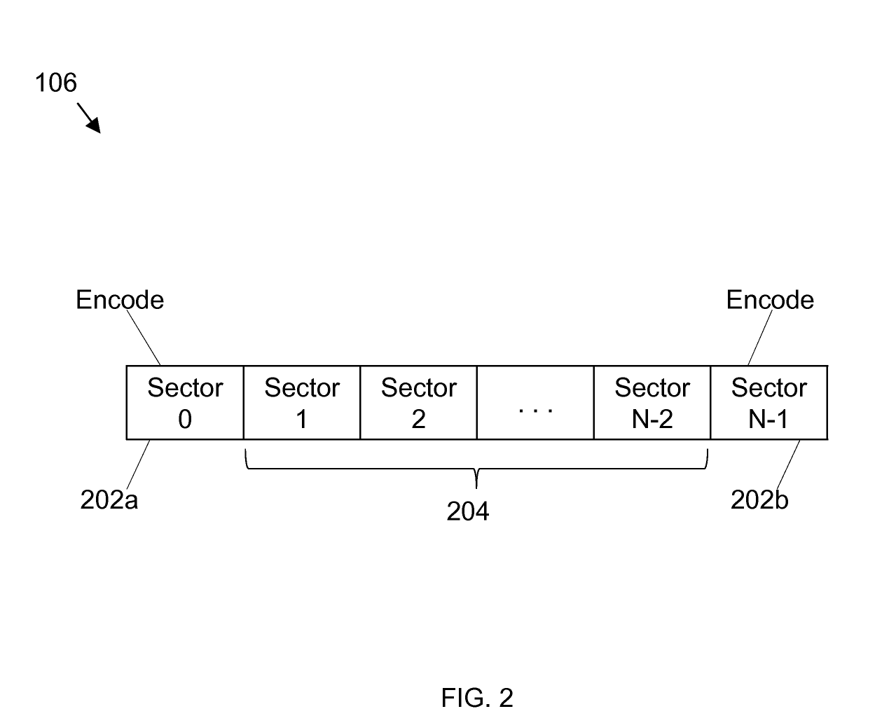

FIG. 2 illustrates an example block diagram of target device 106, in accordance with some embodiments of the present disclosure. Target device 106 includes sectors 202a-202b, 204. The locking of target device 106 can include encoding some sectors on target device 106. In some embodiments, examples of encoding can include inverting at least a subset of bits in target device 106. For example, some or all bits in sector 0 (202a) or sector N−1 (202b) of a target device having N sectors can be inverted. In some embodiments, encoding can include compressing the byte region, and optionally padding the byte region if the compressed size is smaller than the byte region. The encoding can generally include an encoding scheme that overwrites the byte region, such that an operating system in another host becomes unable to mount target device 106.

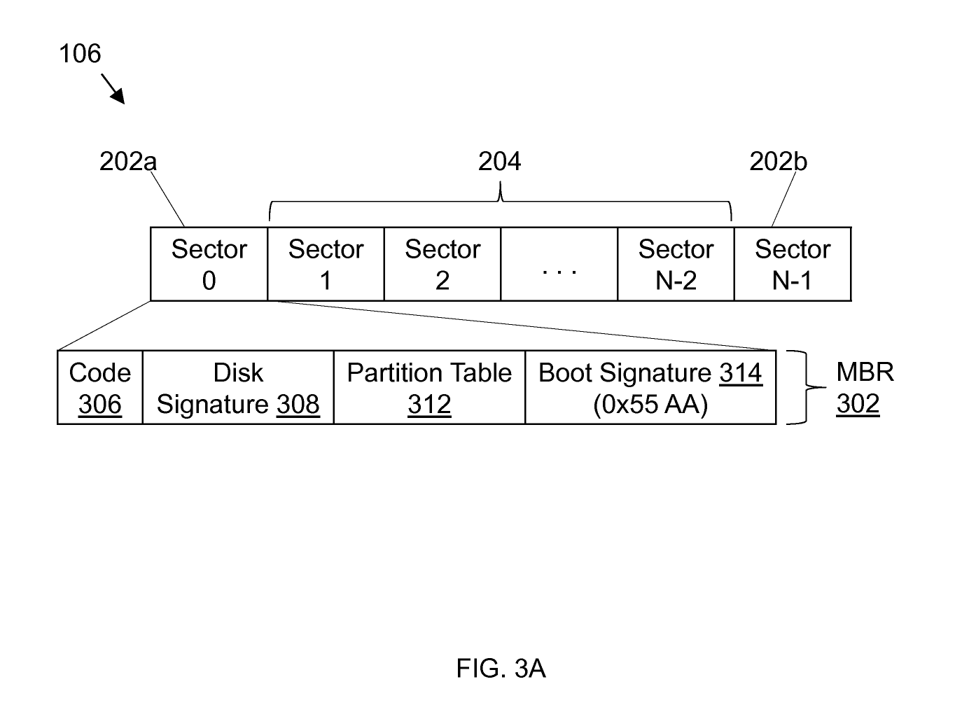

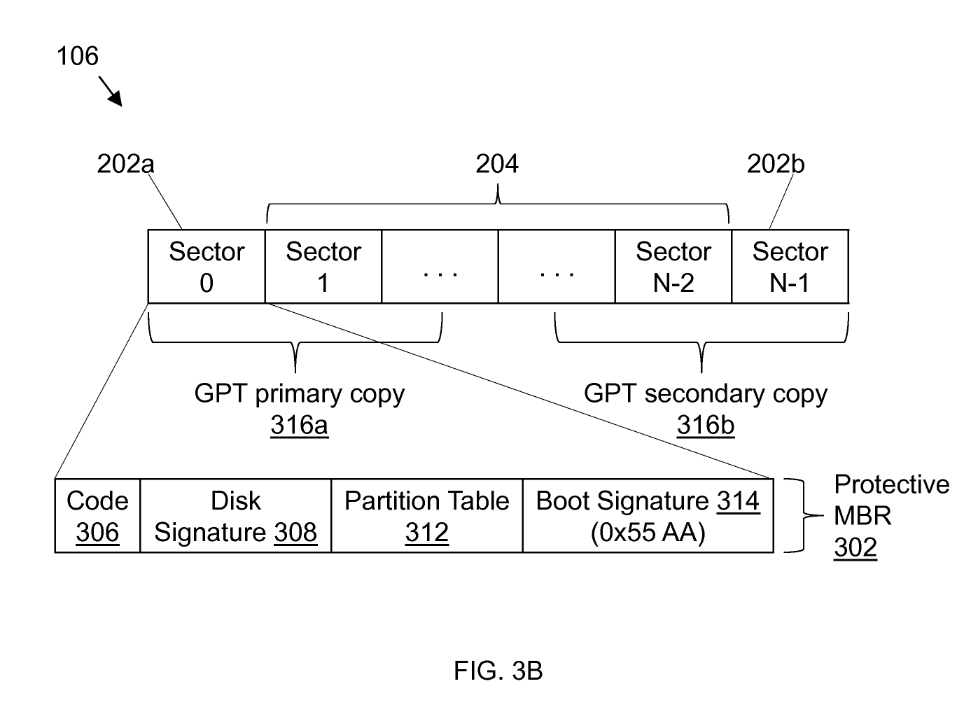

FIG. 3A illustrates an example block diagram of target device 106 including master boot record (MBR) 302, in accordance with some embodiments of the present disclosure. Target device 106 includes sectors 202a-202b, 204. Sector 0 (202a) includes master boot record (MBR) 302. MBR 302 includes code 306, disk signature 308, partition table 312, and boot signature 314. Disk signature 308 can be an optional universally unique identifier (UUID) for a target device. That is, disk signature 308 can be used by some operating systems to identify a target device. Examples of operating systems that can use disk signature 308 include MICROSOFT WINDOWS. However, not all operating systems use disk signature 308. For example, UNIX and LINUX operating systems generally may not provide a unique identifier for target devices. As a result, some embodiments also determine a unique identifier for use by the cache to associate with target device 106.

MBR 302 can generally be 512 bytes in size. Accordingly, embodiments that include locking target device 106 by encoding multiple sectors (such as a first 16 kB, or sector 0 (202a)) automatically include encoding the 512-byte contents of MBR 302, because the entire MBR (512 bytes) is included within the first 16 kB being encoded. In some embodiments, the system locks target device 106 by making partition table 312 unreadable by another host that tries to mount target device 106. Partition table 312 describes a layout of files and data stored on target device 106 (i.e., a file system) to the operating system. A disk manager in an operating system can generally use partition table 312 to make a device accessible for reading and/or writing. In some embodiments, the partition table is made unreadable by encoding at least a subset of bits or sectors stored in target device 106 that relate to partition table 312. For example, the encoding can include inverting multiple sectors such as the first 16 kB (including at least sector 0 (202a)) found in target device 106. The system can encode any other amount of bytes or sectors to prevent target device 106 from being mountable in other systems. In further embodiments, the system can encode multiple sectors such as the last 16 kB (including at least sector N−1 (202b)) of target device 106. Other sizes for the byte region can be chosen based on design and/or implementation requirements relating to the cache, target device, and corresponding partition tables.

In some embodiments, the system can lock target device 106 by switching boot signature 314 of MBR 302 to a different value. Generally, boot signature 314 can indicate the presence of a boot loader that allows target device 106 to be mounted and loaded for use in an operating system. Boot signature 314 is generally standardized to have the value 0x55AA in devices configured with MBR. (The value 0x55AA can also be described as 0xAA55, depending on whether the system in use stores most significant bits or least significant bits in increasing memory addresses.) If the MBR is generally 512 bytes in size, then boot signature 314 can generally be the 510th bytes (0x55) and 511th bytes (0xAA) of MBR 302. In some embodiments, the system can modify the first 16 kB (or one or more sectors) of target device 106, which would include modifying boot signature 314. In other embodiments, the system can perform a targeted modification of boot signature 314 only, without modifying the remainder of MBR 302 and without modifying other sectors. In general, an MBR containing a different value for boot signature 314 could be considered invalid by a basic input/output system (BIOS) and/or by a corresponding operating system on another host. Accordingly, an operating system in another host would not mount target device 106 modified according to the mount prevention, because target 106 would appear to the other host to be missing the required 0x55 AA value for boot signature 314. The system can thereby avoid unwanted modifications by the other host of partition table 312 or any other sectors of target device 106.

FIG. 3B illustrates an example block diagram of target device 106 including a globally unique identifier partition table (GPT), in accordance with some embodiments of the present disclosure. Compared with a master boot record (MBR) partitioning scheme, GPT can generally support more partitions and larger sized devices. A GPT can include GPT primary copy 316a that is 17 kB in size and stored in the first thirty-four sectors of the disk (assuming each sector is 512 bytes). GPT secondary copy 316b can be stored in the last thirty-four sectors of the disk. The first 512 bytes (i.e., sector 0) of the GPT contains protective MBR 302, formatted in a similar manner as described in connection with FIG. 3A. The disk manager in an operating system can use a GPT partitioning scheme to determine partitions on the target disk and the starting offset of these partitions, to ultimately mount the partitions on the target device. As described earlier, in some embodiments multiple sectors can be encoded, such as the first 16 kB found in target device 106. As a result, the system can encode most bytes corresponding to a partition table on GPT primary copy 316a and supporting metadata that would be used by an operating system on another system to mount a target device using a GPT partition scheme. The system can encode any other amount of bytes or sectors to prevent target device 106 from being mountable in other systems, such as a byte region corresponding to one or more individual partitions, partition boot records (PBR), or volume boot records (VBR) on partitions of the target device. In some embodiments, the system can encode additional sectors such as the last 16 kB of target device 106, corresponding to a partition table on GPT secondary copy 316b that an operating system in another host might use as a backup partition table to mount the target device. Accordingly, by encoding both a first 16 kB and a last 16 kB of target device 106, locking target device 106 can stop an operating system from loading either a primary or a secondary partition table according to a GPT partition scheme.

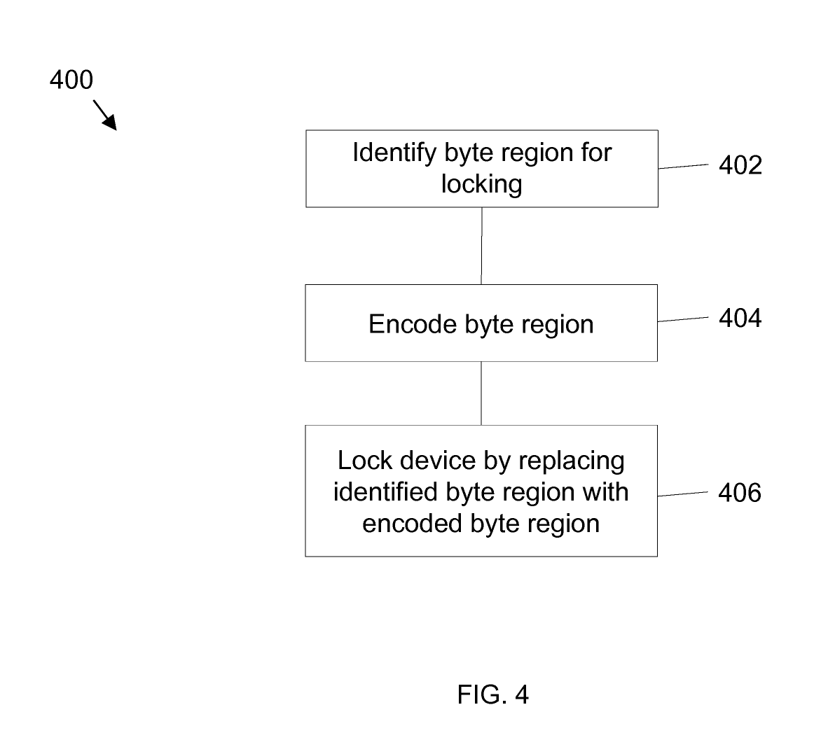

FIG. 4 illustrates an example method 400 for locking a target device, in accordance with some embodiments of the present disclosure. Method 400 can include identifying a byte region on a target device to encode (step 402), encoding the identified byte region (step 404) and locking the storage device by replacing the identified byte region with the encoded byte region on the target device (step 406).

Identifying a byte region on a target device to encode (step 402) can include identifying a location and contents of the byte region. In some embodiments, the byte region can be identified based on having a preferred location and/or based on having a preferred value. For example, the byte region can include a region related to a partition table. An example of a byte region can include a boot signature as used in a master boot record (MBR) or globally unique identifier partition table (GPT) partitioning scheme. The boot signature can have a known location (e.g., the 510th and 511th bytes of the MBR) and a known value (e.g., 0x55 AA). Another example of a byte region can include a first sixteen kilobytes of the target device. The first sixteen kilobytes can exhibit a known location (e.g., the first thirty-two sectors of a device using sectors of 512 bytes, or the first four sectors of a device using sectors of 4 kB) but not necessarily known values or contents. A further example of a byte region can include a first sixteen kilobytes and a last sixteen kilobytes of the target device.

In some embodiments, encoding the identified byte region (step 404) can include reading the identified byte region, and inverting the bits in the byte region. The encoding can have the effect of locking the target device to prevent the device against mounting in an outside host. In some embodiments, the encoding can include replacing the boot signature with a unique signature or unique identifier. Embodiments can also use temporary space allocated on the cache.

Finally, method 400 can include locking the storage device by replacing the identified byte region with the encoded byte region on the target device (step 406). In some embodiments, locking includes replacing the boot signature with the unique signature or unique identifier determined earlier. In some embodiments, the locking includes performing the replacement in a single atomic transaction to the target device, to improve data integrity. This precaution means that the present systems replace the entire identified byte region with the encoded byte region if the operation completes successfully, or the present systems revert the replacement so that the entire byte region remains in its original state.

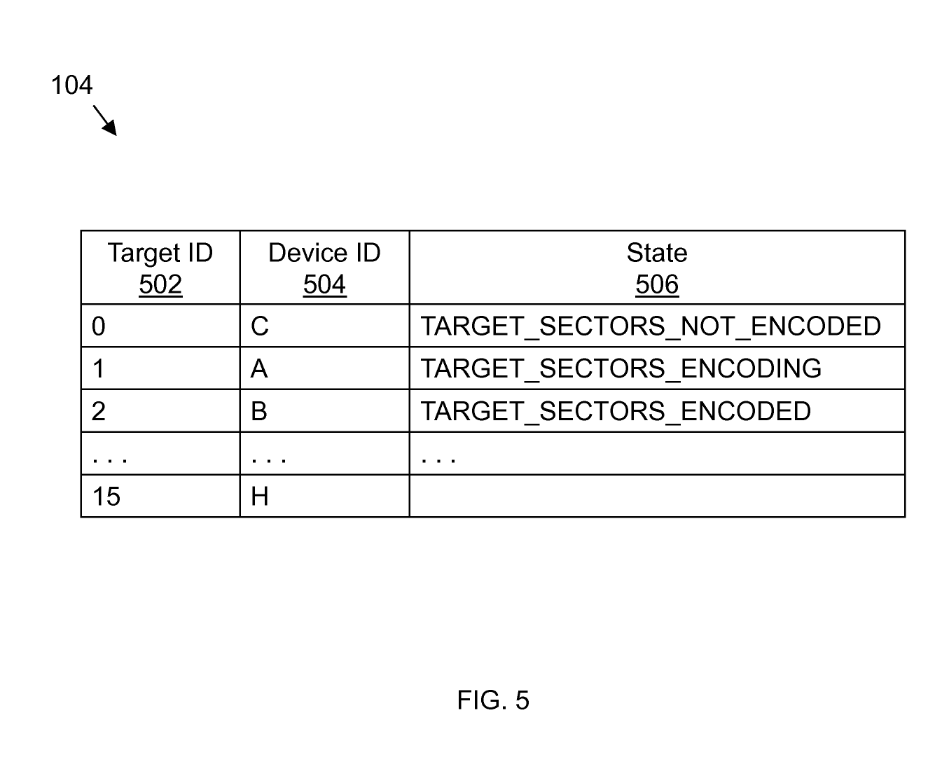

FIG. 5 illustrates an example temporary space on cache 104, in accordance with some embodiments. FIG. 5 illustrates a mapping on cache 104 that tracks target identifiers 502, device identifiers 504, and state variables 506. In some embodiments, the system can encode the byte region in a single atomic transaction by using temporary space on cache 104 to track intermediate states. For example, the tracking can include using a state variable to indicate the state of the lock for a particular target identifier 502 and a particular device identifier 504. For a newly cached target device, the state variable could be set to TARGET_SECTORS_NOT_ENCODED. When the system reads the identified byte region, such as from the first 16 kB and last 16 kB of the target device, and stores the identified byte region on cache 104, the state variable can be set to TARGET_SECTORS_ENCODING. After the system has completed encoding the identified byte region, the system can write the encoded data to the target device. For example, if the identified byte region includes the first 16 kB and last 16 kB of the target device, the system can write the encoded first 16 kB and updated boot signature to the target device. The system can proceed to write the encoded last 16 kB to the target device, and set the state variable to TARGET_SECTORS_ENCODED. The system preserves data integrity by ensuring that, at any time, only one piece of data is being encoded. If the encoding does not complete, for example due to system failure or power failure, the encoding can be restarted after the previous successful step without undesired data loss.

In some embodiments, the target device can become available or unavailable dynamically, during the runtime of the cache. When a target device becomes unavailable, the cache may not take action in response. When a target device becomes available, the cache can check the state variable to determine whether the target was encoded (e.g., TARGET_SECTORS_ENCODED). If the target device was encoded, the cache can verify the boot signature to confirm that an outside host did not inadvertently modify the target drive. If the cache detects that the boot signature is still the same (i.e., is still the unique signature as expected), the cache can start filtering the drive. If the cache receives any I/O operations that fall in the encoded region, the cache can revert, or decode, the data before returning the data back to the requestor. However, if the cache detects that the boot signature has changed, the cache can generate a warning that the target device was modified in an outside host and does not filter the target. The cache can also fail all I/O operations to the target device, to avoid further data corruption and can identify the situation as needing user intervention.

If the user intentionally desires to modify a target device on a different host, then the user could reinitialize the target disk before further modification. For example, the user could reformat the target disk or reparation desired partitions in the target disk. Reinitializing the target disk can recreate the MBR/GPT partition table. In some embodiments, if a reinitialized device is remounted on the original system that locked the device, then the cache can identify that the reinitialized device has been modified outside the original system by determining that the expected byte regions are no longer encoded. If the user brings a device modified in this fashion back to the host, the cache could detect that the device has been modified outside the host. For example, the cache can determine that a corresponding boot signature is different. The cache could then evict, or discard, cached data corresponding to the target device and thus, prevent data corruption when used with the mount prevention.

In some embodiments, a utility or module can be used to unlock, or decode, a target device. This unlock utility can remove or decouple dependencies that would otherwise be required for the unlock utility to unlock the target device. For example, because the locking does not rely on storing the original data from the target device onto the cache, the unlock utility can be a standalone utility that simply inverts the encoded byte region, to unlock the device.

### Unique Identifier Generation for Storage Devices

Embodiments of the present systems and methods generate a universally unique identifier (UUID) for a target device, without requiring the unique identifier to be recorded to a storage partition and without requiring additional storage space to be used on the target device. Instead of recording the unique identifier to a storage partition or using additional storage space, the unique identifier generation can include modifying a byte region of the target device based on the unique identifier. The byte region can be selected based on having a known location and/or known contents. Because the byte region can reside on the target device in space that is otherwise unavailable as a storage partition or as storage space, the unique identifier generation can avoid recording the unique identifier to a storage partition and avoid using additional storage space on the target device. In some embodiments, the generated unique identifier can be further used to provide mount prevention or locking based on the selected byte region. In some embodiments, the system can further select the byte region so as to prevent an operating system in another host from mounting the target device.

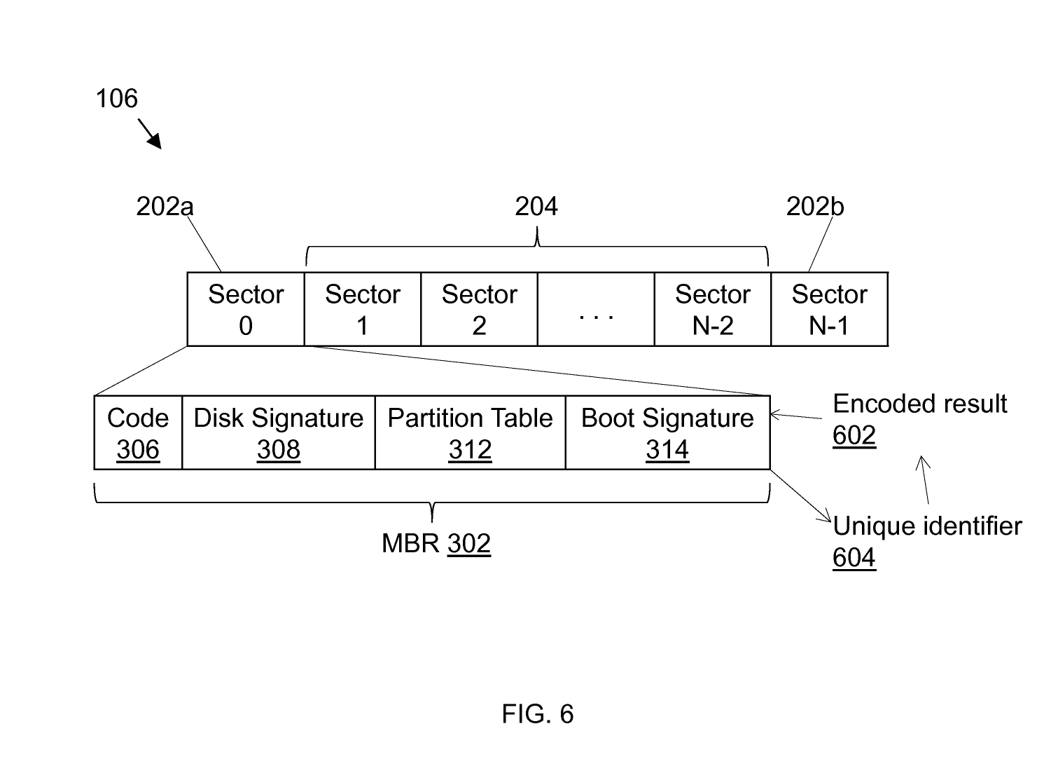

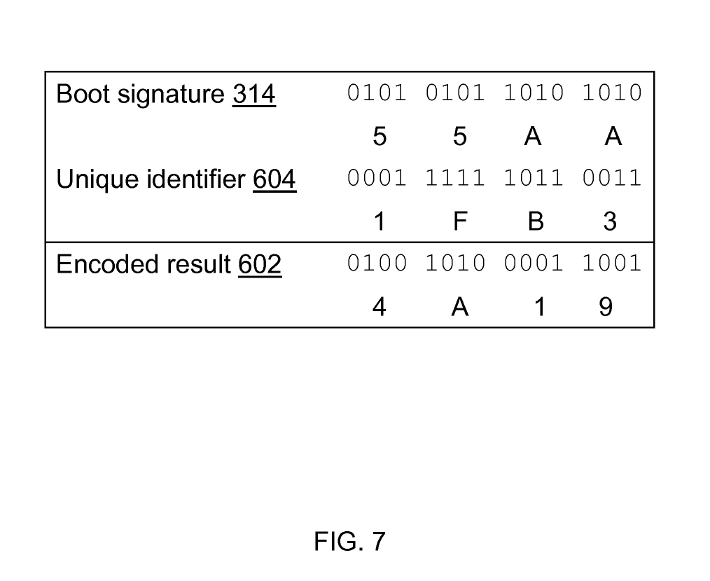

FIG. 6 illustrates an example block diagram of target device 106 including master boot record (MBR) 302, in accordance with some embodiments of the present disclosure. Target device 106 includes sectors 0 through N−1 (202a-202b, 204). Sector 0 (202a) includes master boot record (MBR) 302. MBR 302 includes code 306, disk signature 308, partition table 312, and boot signature 314. Unique identifier generation can replace boot signature 314 with encoded result 602, based on unique identifier 604. Because MBR 302 can be expected to reside in a known location such as sector 0 (202a), the system can associate the generated unique identifier with a byte region in the known location on the target device. In some embodiments, the byte region can be boot signature 314. Accordingly, some embodiments can include modifying boot signature 314. For example, the boot signature 314 can be modified using generated unique identifier 604 to create encoded result 602, and target device 106 can be locked by replacing boot signature 314 with encoded result 602. An example of unique identifier 604 can include 0x1F B3. The system can encode result 602 based on unique identifier 604 and boot signature 314. For example, the modification can include encoding result 602 to have the value 0x4A 19, by performing XOR bit operations to XOR unique identifier 604 with boot signature 314 (shown in FIG. 7). The system can then lock the target device by replacing boot signature 314 with encoded result 602 (i.e., value 0x4A 19). In another embodiment, the unique identifier generation can use unique identifier 604 as encoded result 602, and directly replace boot signature 314 with unique identifier 604 (i.e., replace boot signature 314 with the value 0x1F B3 of unique identifier 604 directly, rather than XOR'ing unique identifier 604 with boot signature 314 to derive the value 0x4A 19).

Furthermore, upon remounting the target device, the system can determine that the associated unique identifier 0x1F B3 (604) locked the target drive based on reverse mapping. That is, the system can determine that 0x1F B3 is the unique identifier that converts encoded result 0x4A 19 (602) back to boot signature 0x55 AA (314). Therefore, unique identifier 0x1F B3 (604) identifies target device 106, without the system having to actually store the byte values 0x1F B3 to a storage area of target device 106. Accordingly, the system does not require additional storage space on target device 106 and is still able to uniquely identify that target device 106 corresponds to unique identifier 0x1F B3, based on modifying boot signature 314 to be encoded result 602.

Although FIG. 6 illustrates an example of unique identifier generation using a master boot record (MBR), some embodiments can use other partition tables such as global unique identifier partition tables (GPT), individual partition boot records (PBR) or volume boot records (VBR) corresponding to partitions on target device 106, and/or file systems on target device 106.

FIG. 7 illustrates an example of modifying a byte region on a target device based on unique identifier 604, in accordance with some embodiments of the present disclosure. FIG. 7 includes boot signature 314, unique identifier 604, and encoded result 602. FIG. 7 illustrates encoding result 602 based on sample unique identifier 604 having value 0x1F B3 and sample boot signature 314 having value 0x55 AA, although other values for unique identifier 604 and boot signature 314 can be used. In some embodiments, the byte region being modified on the target device can be boot signature 314. Boot signature 314 has a known value (0x55 AA) and known location (generally the 510th and 511th byte of the master boot record in sector 0). Accordingly, the byte region can be found in a known location of the target device.

In some embodiments, modification of boot signature 314 can include performing bitwise XOR operations with unique identifier 604. Although FIG. 7 illustrates modification and replacement of boot signature 314, other byte regions can also be used. For example, the system can modify an initial sector of the target device, an initial 4-16 kB of the target device, or an initial and final 4-16 kB of the target device. In some embodiments, the byte region can be chosen to encompass bytes or regions generally used by an operating system on another host to load a boot sector or partition table. The exclusive or (XOR) operation results in a logical 1 if two input bits are different, and a logical 0 otherwise. (For example, 0 XOR 1=1 and 1 XOR 0=1. In contrast, 0 XOR 0=0 and 1 XOR 1=0.)

Because boot signature 314 contains sixteen bits (or two bytes), there can be 2¹⁶=65,536 possible values for unique identifier 604 and encoded result 602. If the unique identifier generation uses a different byte region on the target device, the number of available unique identifiers can increase or decrease. For example, the byte region can be a sector and the unique identifier generation can modify an entire sector of 4 kB on the target device. Accordingly, such a unique identifier corresponding to a sector can have a size of 4 kB (4,096 bytes).

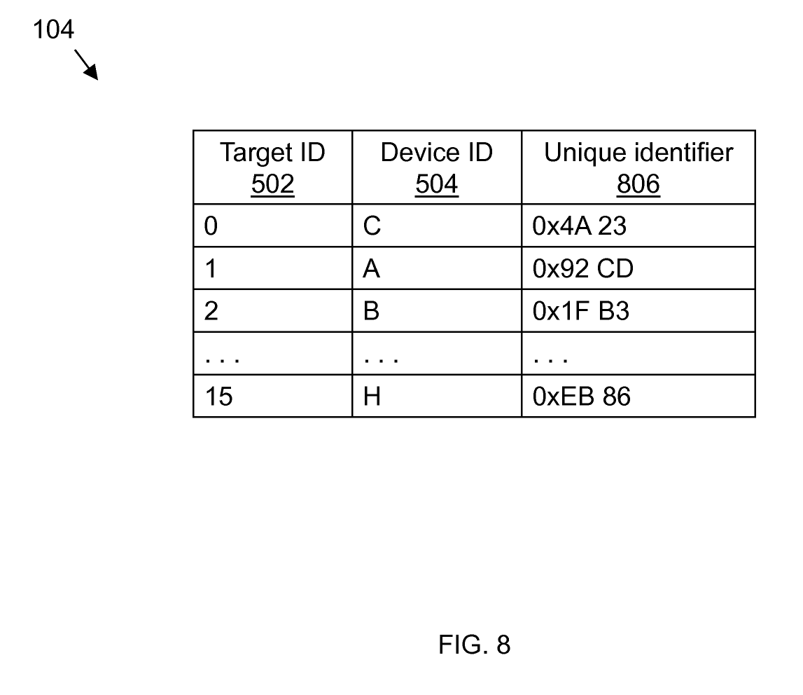

FIG. 8 illustrates an example target device mapping on cache 104, in accordance with some embodiments of the present disclosure. The target device mapping includes target identifiers 502, device identifiers 504, and unique identifiers 806.

Some embodiments of the system can support up to sixteen target devices using cache 104. In cache 104, these targets can be referred to using target device identifiers such as target 0-15. Target identifiers 502 can also be associated with device identifiers 504. For example, target 0 can map to device C, target 1 can map to device A, target 2 can map to device B, target 15 can map to device H, etc. The system can also generate a unique identifier for each device. Therefore, up to sixteen unique identifiers can be generated for a system caching sixteen target devices.

Upon system startup of a host system (or upon attaching a target device to the host system), the target device can be mounted. In some embodiments, the mounting includes regenerating unreadable contents of the target device based on identifying a corresponding unique identifier that unlocks the target device. For example, the system can iterate through the list of unique identifiers 806. For each unique identifier in the list, the system can XOR the unique identifier with the relevant (now encoded) byte region of the target device. When the system identifies a corresponding unique identifier that provides valid data, the system can determine that it has unlocked the target device and recovered a mapping between a target device ID and the underlying device mapping. For example, if the encoded byte region originally corresponds to an MBR boot signature, then the expected valid data can be 0x55 AA. The system can determine that the unique identifier that regenerates the expected value of 0x55 AA for the boot signature unlocks the device. In some embodiments, if the system has iterated through all unique identifiers 806 to combine with the contents of the device without arriving at valid data, then the outside mount prevention can conclude that the target device is not intended for use in the host system. For example, if none of the unique identifiers results in the expected value of 0x55 AA for the MBR boot signature when combined with the encoded byte region on the target device, the system can conclude that the target device is not intended for use in this host system.

In some embodiments, the system can identify a unique identifier that regenerates valid data as follows. First, the system can store the original data from the target device on cache 104. Then, the system identifies the corresponding unique identifier by combining the unique identifier with the encoded byte region on the target device, and comparing the resulting regenerated data with the stored original data. However, storing the original data on cache 104 can create an undesired dependency on cache 104. For example, such a design may not allow the target device to be unlockable if the original host system and cache 104 are lost, because the original data would be lost in such a scenario. Second, if a boot signature is used as the selected byte region on the target device, the system can select the unique identifier that regenerates the boot signature 0x55 AA when combined with the encoded byte region on the target device. Third, if one or more sectors are used as the selected byte region on the target device, the system can select the unique identifier that results in the target device including the regenerated data being recognized by an operating system as containing a file system. Examples of operating system utilities to recognize whether the target device contains a file system can include a “blkid” (BLocK ID) or “lsblk” (LiSt BLocK) utility such as those found on LINUX operating systems. In some embodiments, similar utilities for other operating systems can also be used to evaluate regenerated data. Once the system identifies valid data, the data can be considered to be a match and the system can proceed to unlock the target device, and load and cache the data as desired.

Some embodiments can expand the number or universe of available unique identifiers, for example beyond sixteen. For example, it can be useful to use different unique identifiers for different configurations of the present systems and methods. Otherwise, when moving target devices between deployments, similar identifiers could collide or conflict. In some embodiments, the number of available unique identifiers can be about 64,000. This is because the master boot record (MBR) can have a 2-byte boot signature (0x55 AA), which is then replaced with the unreadable encoded data for the outside mount prevention. Thus, there are about 64,000 unique identifiers that do not arbitrarily result in an MBR's boot signature when the encoded result is XOR′ ed with the unique identifier. With 16 target devices and about 64,000 unique identifiers, the chance of a collision can be about 16/64,000=0.00025, or 0.025%. This error rate generally allows the system to protect users from their own undesired behavior of using in another host a target device originally mounted in a first host.

In some embodiments, the unique identifier generation can use a master boot record (MBR) disk signature as a unique identifier, if the corresponding operating system supports the MBR disk signature field. Examples of operating systems that support the MBR disk signature field include WINDOWS. Some embodiments can generate the unique identifiers according to a random function. In this manner, the unique identifier generation can support operating systems such as LINUX that may not provide a unique identifier. In some embodiments, the random function can use a hard-coded, globally constant seed to generate the unique identifiers, since the unique identifiers are static and do not need to change dynamically. However, using a globally constant seed in the random function means the unique identifiers could be identical on every deployment of the present systems, which could lead to undesirable collisions. Accordingly, the unique identifier generation can address this issue by generating a universe or collection of 64,000 unique identifiers, and selecting sixteen unique identifiers from the universe of 64,000 unique identifiers. For example, the method could use a random function to select the unique identifiers from the universe of unique identifiers. The unlock utility described earlier (used if the first system and the cache are lost, or if the user otherwise wants to “unlock” the drive outside of the system) can iterate through the universe of unique identifiers until the unlock utility identifies the correct unique identifier to unlock the drive.

In some embodiments, upon receiving a command to remove or unmount a target device from the cache and operating system, the systemcan generate a different unique identifier for the new target drive. Furthermore, the system can also unlock the target device. Otherwise, assume the user issues a command to remove, for example, target device ID 3 from the cache configuration, but the actual target device is not attached when the user attempts to remove the target device. Further assume that a new target device becomes assigned to target device ID 3. The result could be an undesired collision in which two disks, the old target device and new target device, can both be unlocked using the same unique identifier. That is, without generating a new unique identifier, the system could be left unable to tell the difference between the two disks, which could lead to unwanted data corruption.

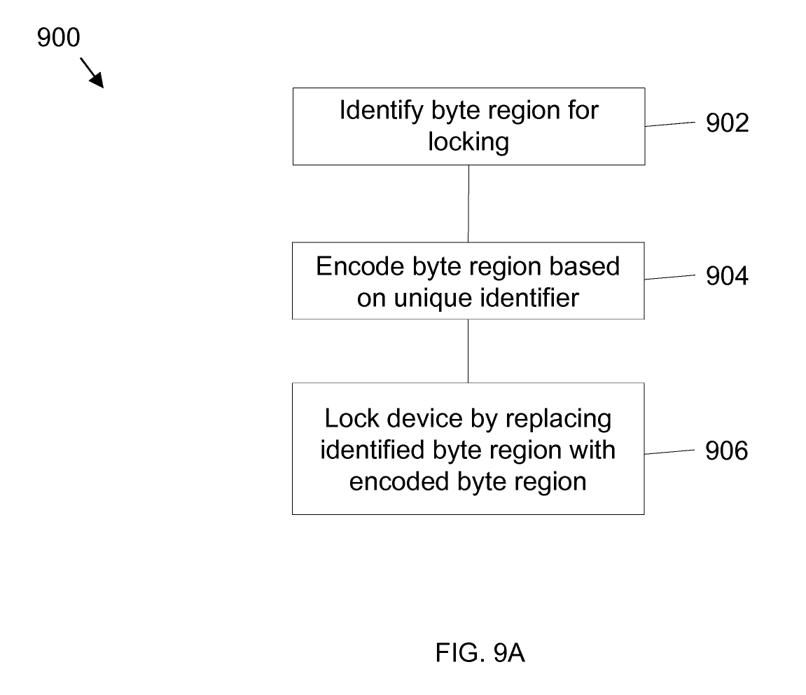

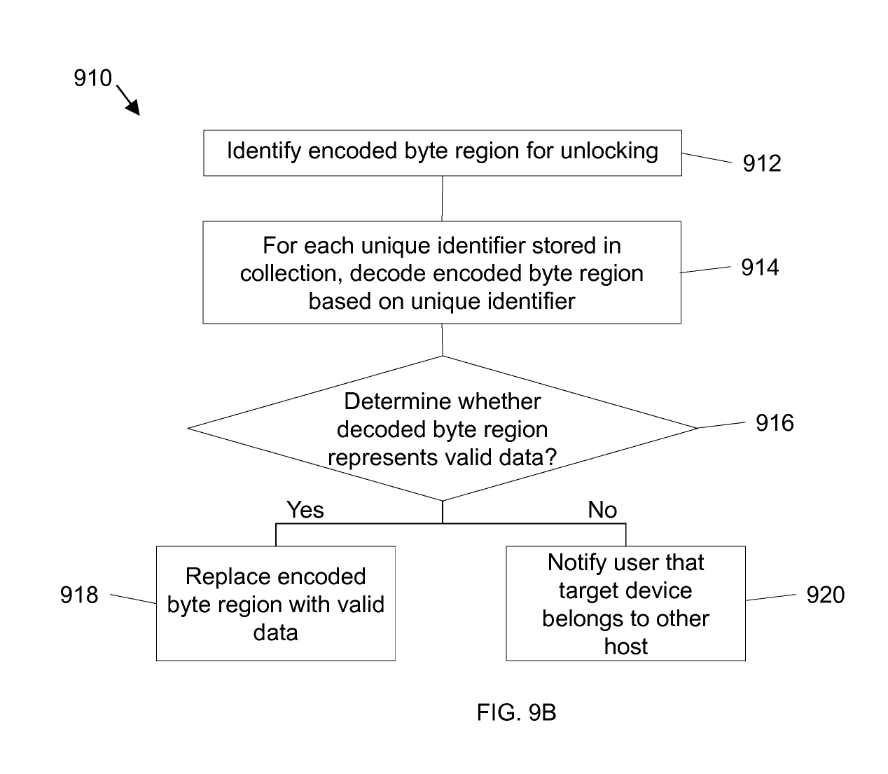

FIG. 9A illustrates a method 900 for locking a target device using a unique identifier, in accordance with some embodiments of the present disclosure. Method 900 can include identifying a byte region to encode (step 902); encoding the identified byte region based on a unique identifier (step 904); and replacing the identified byte region with the encoded byte region (step 906).

First, method 900 can identify a byte region to encode (step 902). The identified byte region can include at least a boot signature of a target device, such as the boot signature used with master boot record (MBR) or globally unique identifier partition table (GPT) partitioning schemes. The identified byte region can also include additional data, such as a first sector of the target device, or multiple sectors at the beginning of the target device (such as a first 4 kB or first 16 kB).

Next, method 900 can include encoding the identified byte region, based on a unique identifier (step 904). In some embodiments, the encoding can include performing a bitwise XOR operation with the identified byte region and the unique identifier. The system can replace the identified byte region with the encoded byte region (step 906). Accordingly, the present systems are able to prevent the target device from mounting in another host.

FIG. 9B illustrates a method 910 for unlocking a target device, in accordance with some embodiments of the present disclosure. Method 900 can include identifying an encoded byte pattern on the target device (step 912); decoding the encoded byte pattern, based on the unique identifier (step 914) and determining whether the decoded byte pattern results in valid data (step 916); if yes, replacing encoded byte region with valid data (step 918); and if no, notifying a user that the target device belongs to another host (step 920). For example, the system can perform the unlocking upon receiving a mount request to mount a target device, or an unmount request to remove a target device. For each unique identifier stored in a collection of unique identifiers on the system, the system can decode the encoded byte pattern, based on the unique identifier (step 914).

Next, method 910 determines whether the decoded byte pattern results in valid data (step 916). In some embodiments, the determination of whether the decoded byte pattern results in valid data includes comparing the decoded byte pattern with original data from the target device stored on the cache. As described earlier, storing the original data on the cache can introduce a dependency on having the cache available when decoding the target device. In some embodiments, if a boot signature was used as the identified byte region on the target device, the determination of whether the decoded byte pattern results in valid data can include comparing the decoded byte pattern to the value 0x55 AA to determine whether the decoded byte pattern matches the boot signature. In some embodiments, if one or more sectors are used as the identified byte region on the target device, the determination of whether the decoded byte pattern results in valid data can include determining whether an operating system recognizes the target device including the decoded byte region as containing a file system. Examples of operating system utilities to recognize whether the target device contains a file system can include a “blkid” (BLocK ID) or “lsblk” (LiSt BLocK) utility such as those found on LINUX operating systems. In some embodiments, similar utilities for other operating systems can also be used to evaluate regenerated data.

If the decoded byte pattern results in valid data (step 916: Yes), the system can replace the encoded byte pattern with the valid data (step 918), which can result in unlocking the device. If the decoded byte pattern does not result in valid data (step 916: No), the system can notify the user that the target device belongs to another host (step 920).

Those of skill in the art would appreciate that the various illustrations in the specification described herein can be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware, software, or a combination depends upon the particular application and design constraints imposed on the overall system. Skilled artisans can implement the described functionality in varying ways for each particular application. Various components and blocks can be arranged differently (for example, arranged in a different order, or partitioned in a different way) all without departing from the scope of the subject technology.

Furthermore, an implementation can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general-purpose computer system with a computer program that, when being loaded and executed, controls the computer system such that it carries out the methods described herein. The methods can also be embedded in a computer program product, which comprises all the features enabling the implementation of the methods described herein, and which, when loaded in a computer system is able to carry out these methods.

A computer program or application in the present context means any expression, in any language, code or notation, of a set of instructions intended to cause a system having an information processing capability to perform a particular function either directly or after either or both of the following a) conversion to another language, code or notation; b) reproduction in a different material form. The present systems and methods can be embodied in other specific forms without departing from the spirit or essential attributes thereof, and accordingly, reference should be had to the following claims, rather than to the foregoing specification, as indicating the scope of the present systems and methods.

The present disclosure has been described in detail with specific reference to these illustrated embodiments. It will be apparent, however, that various modifications and changes can be made within the spirit and scope of the disclosure as described in the foregoing specification, and such modifications and changes are to be considered equivalents and part of this disclosure.

1. A method for locking a storage device, the method comprising:
selecting, on a storage device, a location and contents of a byte region for locking, wherein the byte region comprises a boot sector of the storage device;
encoding the selected contents of the byte region; and
locking the storage device by replacing the contents of the identified byte region with the encoded byte region at the identified location on the device.

2. The method of claim 1, wherein encoding the selected contents of the byte region comprises at least one of inverting the contents of the selected byte region using a binary not operation and compressing the contents of the selected byte region.

3. The method of claim 1, wherein encoding the selected contents of the byte region is performed on a cache, and wherein the cache is separate from the storage device.

4. The method of claim 1, wherein locking the storage device comprises copying the encoded contents of the byte region from the cache to the identified location on the device in an atomic transaction.

5. The method of claim 1, wherein the boot sector is arranged according to at least one of a master boot record (MBR) partition scheme and a globally unique identifier partition table (GPT) partition scheme.

6. The method of claim 5, wherein the byte region comprises an MBR boot signature.

7. The method of claim 1, wherein the byte region comprises at least one of (i) sector 0 of the storage device, (ii) a plurality of initial sectors of the storage device, (iii) an initial about 4-16 kilobytes of the storage device, and (iv) a partition boot record (PBR) for an individual partition on the storage device.

8. The method of claim 7, wherein the byte region comprises at least one of a plurality of final sectors of the storage device, and a final about 4-16 kilobytes of the storage device.

9. The method of claim 1, wherein encoding the selected contents of the byte region comprises modifying the selected contents of the byte region based on a generated unique identifier.

10. The method of claim 9, wherein encoding the selected contents of the byte region comprises performing a binary exclusive-or (XOR) operation with the generated unique identifier and the byte region.

11. The method of claim 9, wherein the unique identifier is generated according to a random function initiated with a globally constant random seed.

12. A system for locking a storage device, the system comprising:
a storage device, wherein the storage device contains a byte region, and wherein the byte region comprises a boot sector of the storage device; and
a processor in communication with the storage device, wherein the processor is configured to:
select, on the storage device, a location and contents of the byte region for locking;
encode the selected contents of the byte region; and
lock the storage device by replacing the contents of the identified byte region with the encoded byte region at the identified location on the device.

13. The system of claim 12, wherein the processor configured to encode the selected contents of the byte region comprises at least one of the processor being configured to invert the contents of the selected byte region using a binary not operation and the processor being configured to compress the contents of the selected byte region.

14. The system of claim 13, wherein the processor configured to encode the selected contents of the byte region comprises the processor being configured to perform a binary exclusive-or (XOR) operation with the generated unique identifier and the byte region.

15. The system of claim 12, wherein the processor configured to encode the selected contents of the byte region comprises the processor being configured to modify the selected contents of the byte region based on a generated unique identifier.

16. A method for unlocking a storage device, the method comprising identifying an encoded byte region on the storage device;
for each unique identifier stored in a collection of unique identifiers, decoding the encoded byte region based on the unique identifier;
determining whether the decoded byte region represents valid data; and
replacing the encoded byte region with the decoded byte region, upon a determination that the decoded byte region represents valid data.

17. The method of claim 16,
wherein decoding the encoded byte region is performed on a cache, wherein the cache is separate from the storage device; and
wherein determining whether the decoded byte region represents valid data comprises comparing the decoded byte region with original contents of the byte region previously stored to the cache.

18. The method of claim 16,
wherein the byte region comprises a master boot record (MBR) boot signature; and
wherein determining whether the decoded byte region represents valid data comprises comparing the decoded byte region with an original value of 0x55 AA for the MBR boot signature.

19. The method of claim 16, wherein determining whether the decoded byte region represents valid data comprises determining whether an operating system recognizes the storage device as containing a file system.

20. The method of claim 19, wherein determining whether the operating system recognizes the storage device as containing a file system is based on at least one of an lsblk utility and a blkid utility.
